(19) United States
(12) Patent Application Publication
(10) Pub. No.: US 2012/0098246 A1
(43) Pub. Date: Apr. 26, 2012

(54) REPOSITIONABLE NOTEBOOK ACCESSORIES

(75) Inventors: Yangyi He, Quincy, MA (US); Irene Wong, Malden, MA (US); Paul Lukason, Douglas, MA (US)

(73) Assignee: Staples The Office Superstore, LLC, Framingham, MA (US)

(21) Appl. No.: 12/910,401

(22) Filed: Oct. 22, 2010

(51) Int. Cl. B42D 1/00

(52) U.S. Cl. 281/15.1

(57) ABSTRACT

Embodiments are directed to repositionable notebook accessories and methods of using such accessories in connection with a notebook. The repositionable notebook accessory comprises a panel and at least one hook feature configured and arranged to couple the panel to a spine of a notebook when the at least one hook feature is at least partially disposed within the spine. The repositionable notebook accessory may comprise, for example, a divider, a folder and/or an adhesive flag holder.

### FIELD OF THE INVENTION

The invention is generally directed to repositionable accessories (e.g., dividers, folders and adhesive flag holders) for bound items (e.g., notebooks) and methods of using the same.

### BACKGROUND OF THE INVENTION

Notebooks are commonly used by students, professionals, hobbyists, and other individuals to record information such as notes and other writings or sketches. To improve their functionality, accessories such as section dividers and folders have been integrated into such notebooks. These accessories are bound to the notebook in the same manner as the paper of the notebooks. While binding accessories in this manner provides a secure retention mechanism for the accessories, the user is restricted to a single configuration of the accessories, which may not accord with a desired use of the notebook.

### SUMMARY OF THE INVENTION

Applicants have appreciated that conventional notebooks and the like may be improved by allowing more flexibility with respect to accessories, such as dividers and folders. In particular, Applicants have appreciated that it is desirable to allow users to customize a notebook by selecting the type, number and/or position of accessories.

In view of the foregoing, inventive embodiments disclosed herein may relate to accessories that are configured to be added to, removed from and/or repositioned within a notebook, such as a conventional lined paper notebook or other bound item, such as an organizer, planner or artist pad. Examples of such accessories include dividers, folders and adhesive flag holders.

One embodiment is directed to a repositionable notebook accessory comprising a panel and at least one hook feature. The panel comprises a plurality of edges including an attachment edge. Each hook feature comprises a spine attachment portion and a connecting portion that couples the spine attachment portion to the attachment edge of the panel. The at least one hook feature is configured and arranged to couple the panel to a spine of a notebook when the spine attachment feature of each hook feature is longitudinally disposed within the spine.

Another embodiment is directed to a method of using a repositionable notebook accessory in connection with a notebook comprising a spine. The accessory comprises a panel and at least one hook feature coupled to the panel. The method comprises introducing at least a portion of the at least one hook feature into the spine of the notebook at a first location within the notebook so as to couple the accessory to the notebook at the first location.

A further embodiment is directed to a repositionable notebook accessory comprising a panel and at least one hook feature configured and arranged to couple the panel to a spine of a notebook when the at least one hook feature is at least partially disposed within the spine. The repositionable notebook accessory is selected from the group consisting of (1) a divider comprising a tab feature coupled to the panel, (2) an adhesive flag holder comprising a stack of adhesive flags coupled to the panel, and (3) a folder comprising at least one additional panel coupled to the panel, wherein the at least one additional panel is constructed and arranged to form at least one pocket between the panel and the at least one additional panel.

### BRIEF DESCRIPTION OF THE DRAWINGS

FIG. 1 shows a front view of one embodiment of a repositionable divider that may be used in connection with a notebook;

FIG. 2 shows a rear view of the divider;

FIG. 3 shows the divider coupled to a notebook;

FIG. 4 shows an enlarged view of a first spine attachment feature of the divider longitudinally disposed within a spine of the notebook;

FIG. 5 shows the divider coupled to the notebook and rotated with respect to the spine;

FIG. 6 shows a flowchart illustrating an exemplary method for repositioning a notebook accessory within a notebook;

FIG. 7 shows a front view of one embodiment of a repositionable folder that may be used in connection with a notebook;

FIG. 8 shows a rear view of the folder;

FIG. 9 shows the folder coupled to a notebook;

FIG. 10 shows a front view of one embodiment of a repositionable adhesive flag holder that may be used in connection with a notebook;

FIG. 11 shows a rear view of the adhesive flag holder; and

FIG. 12 shows the adhesive flag holder coupled to a notebook.

### DETAILED DESCRIPTION

Following below are more detailed descriptions of various concepts related to, and embodiments of, repositionable notebook accessories and methods of using such accessories. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Existing notebooks are sold with particular accessories, such as dividers and folders, bound at fixed locations within the notebook. The placement, number and type of such accessories may not accord with a desired use of the notebook. Accordingly, there is a need for notebook accessories having greater flexibility of use. In particular, it is desirable to enable notebook accessories to be easily added to, removed from and/or repositioned within a notebook. In addition, it is desirable to enable notebook accessories to be used with different notebooks of the same type or different types. The notebook accessories of embodiments described herein may advantageously exhibit one or more of these features according to some implementations.

### Repositionable Divider

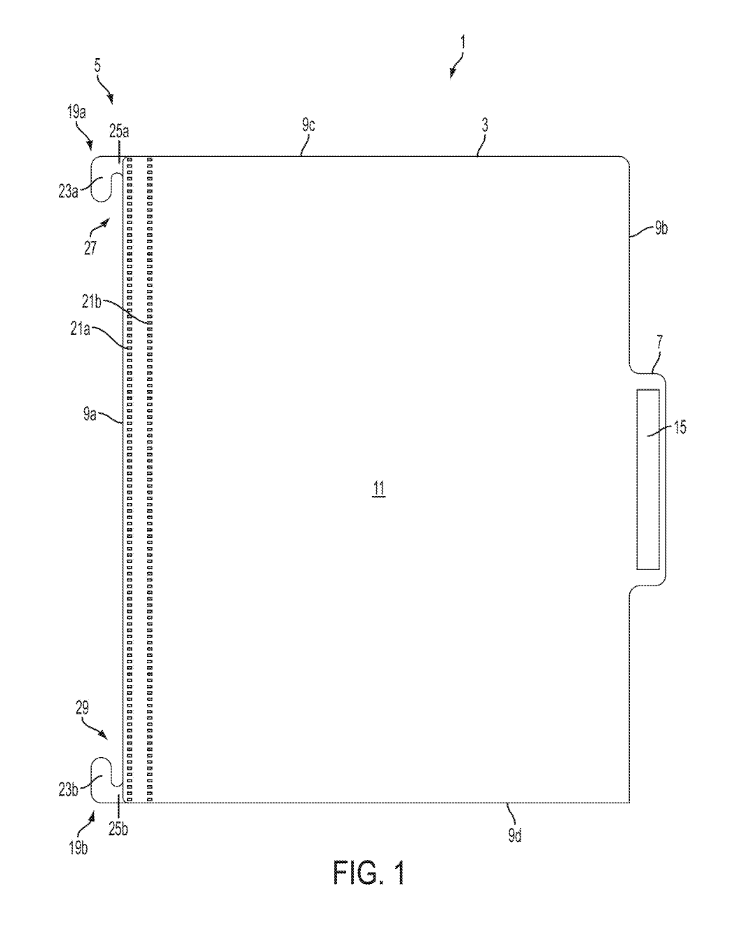

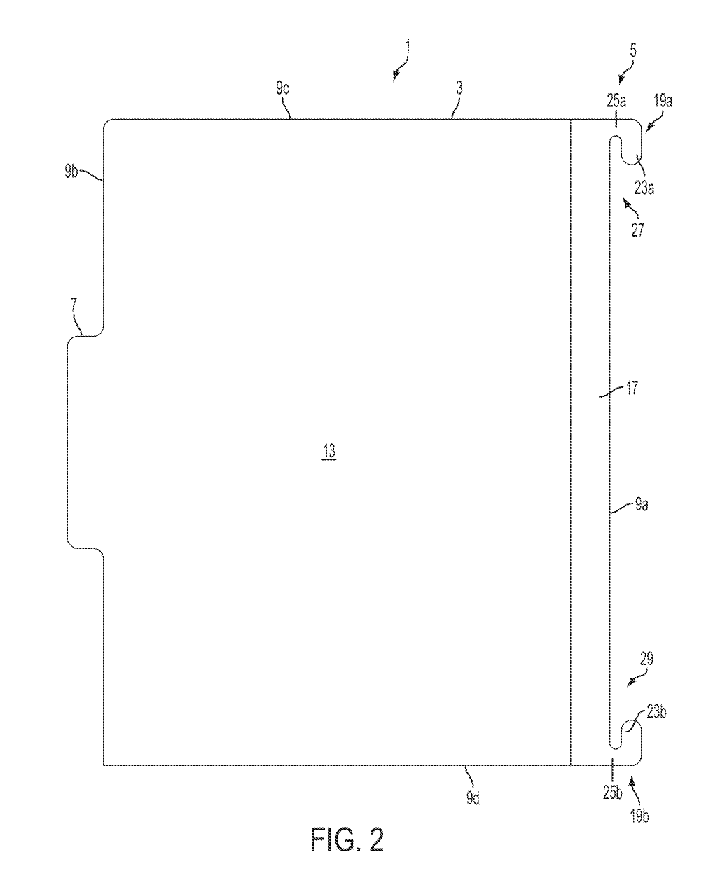

FIGS. 1 and 2 illustrate one embodiment of a repositionable divider 1 that may be used in connection with a notebook. FIG. 1 shows a front view of the divider 1, while FIG. 2 shows a rear view. The divider 1 may be used to divide sections of paper in a notebook, such as sections pertaining to a particular subject or topic. As shown, the divider 1 includes a panel 3, a repositionable notebook attachment feature 5, and a tab feature 7. In the example shown, the repositionable notebook attachment feature 5 is adjacent an attachment edge 9a of the panel 3, while the tab feature 7 is adjacent in an opposite edge 9b of the panel. The panel 3 shown also includes a top edge 9c and a bottom edge 9d.

The panel 3 may have a sheet-like configuration, with a small distance separating its front surface 11 and rear surface 13. For example, the panel 3 may be planar or substantially planar and have a width no greater than 1.00 mm (0.04 in), though other dimensions and configurations are possible. According to one exemplary implementation, the panel 3 is configured to be resiliently flexible. For example, the panel 3 may be composed of a thermoplastic polymer, such as polypropylene, and may be formed by extruding the desired panel shape from a larger sheet of material. Of course, the panel is not limited to any particular material., and other materials, such as paper, may alternatively be used.

According to one exemplary implementation, the panel 3 may be sized to approximate the shape and/or dimensions of notebook paper or covers. For example, the panel 3 may be rectangular or substantially rectangular, and have a width dimension of approximately 21.59 cm (8.50 in) and a height dimension of approximately 27.94 cm (11.00 in). Other shapes and dimensions of the panel are also possible. For example, the panel 3 may be semi-circular, triangular, include less than or more than four main edges, and/or include one or more curved edges rather than straight edges. The panel 3 may have any suitable size, and need not correspond in size to a notebook with which it is used.

The tab feature 7 comprises a protrusion that allows a user to quickly identify and turn to the beginning of a section demarcated by the divider. The tab feature 7 may optionally include a label region 15 to allow a user to identify the subject or topic of a section, for example by writing or typing in the region. The label region 15 may be adhered or otherwise fastened to the tab feature or may be unitarily formed with the tab feature 7. In FIGS. 1 and 2, the tab feature 7 is coupled to the panel 3 at a fixed location on the edge 9b opposite the attachment edge 9a. As used herein, the phrase “coupled to” and variations thereof may refer to features that are integral or non-integral. Thus, portions of a unitary article may be considered coupled although an attachment mechanism such as a weld, adhesive or fastener is not used to couple the portions. In the example of FIGS. 1 and 2, the tab feature 7 is unitarily formed with the panel 3.

It should be appreciated that the tab configuration of FIGS. 1 and 2 is merely exemplary and many alternatives are possible. For example, the tab feature 7 may be coupled to the panel 3 at a fixed location along the top edge 9c or bottom edge 9d or a different location on the opposite edge 9b. Alternatively still, the tab feature 9b may be moveable with respect to the panel 3, for example as described in connection with embodiments described in commonly owned U.S. Pat. No. 7,731,442. In particular, the tab feature 7 may be repositioned or slid along one or more edges of the panel 3. According to yet another alternative, the tab feature 7 may be omitted altogether.

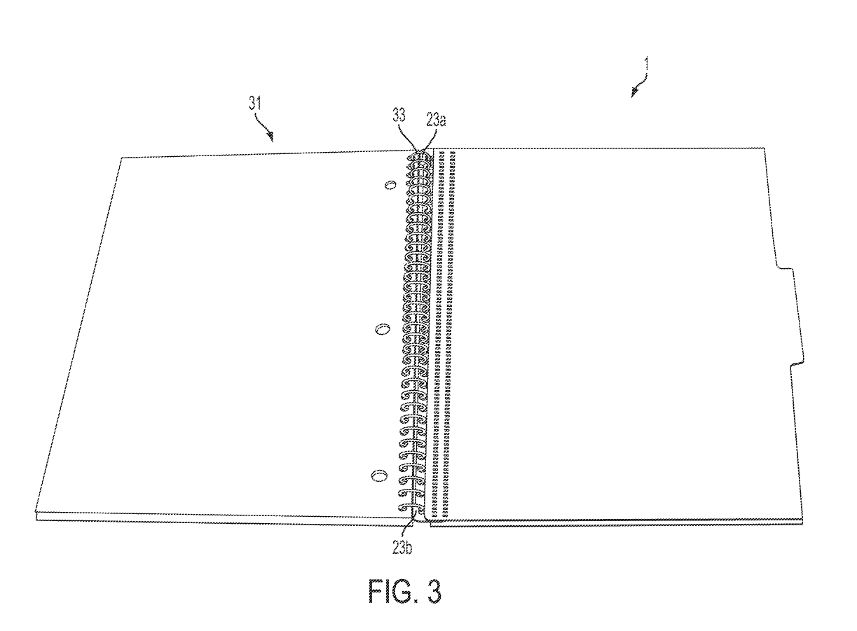

The repositionable notebook attachment feature 5 comprises a reinforcement portion 17 (FIG. 2) and first and second hook features 19a and 19b coupled to the reinforcement portion 17. The repositionable notebook attachment feature 5 is configured to enable the divider 1 to be removably and rotatably coupled to the spine of notebook, as shown in FIGS. 3-5 and will be described in greater detail in connection therewith. The spine may comprise a spiral binding or a comb binding, for example. It should be appreciated that the term “notebook” as used herein may refer to a conventional notebook, such as a lined paper notebook, or other types of bound paper or non-paper items, such as organizers, planners or artist pads.

The reinforcement portion 17 comprises a strip of material, such as polypropylene, that is coupled to the rear surface 13 of the panel 3. The reinforcement portion 17 is optional, and serves to structurally reinforce the panel 3 in the region adjacent the attachment edge 9a. In the example of FIGS. 1 and 2, the panel 3 and the reinforcement portion 17 are coupled via welds 21a and 21b, which may be formed using a welding technique suitable for plastics, such as sonic welding. Energy, such as ultrasonic acoustic vibrations in the case of sonic welding, may be applied to the front surface 11 of the panel 3 at spaced locations along two parallel lines in the region adjacent the reinforcement portion 17, causing the panel and the reinforcement portion to melt together at those regions. Alternatively, another attachment mechanism, such as adhesive or fasteners, may be used, or the reinforcement portion 17 may be unitarily formed with the panel 3.

According to one exemplary implementation, the reinforcement portion 17 may have the same or approximately the same length as the attachment edge 9a of the panel 3. For example, both the attachment edge 9a and the reinforcement portion 17 may be approximately 27.94 cm (11.00 in) long. The width of the reinforcement portion 17 may by approximately 1.50 cm (0.59 in). These dimensions are merely exemplary, as other dimensions may also allow for suitable reinforcement of the panel 3.

The first and second hook features 19a and 19b respectively comprise first and second spine attachment portions 23a and 23b and first and second connecting portions 25a and 25b that couple the spine attachment portions to the attachment edge 9a of the panel 3. The first and second hook features 19a and 19b are configured and arranged to couple the panel 3 to a spine of a notebook, such as the notebook described in connection with FIGS. 3-5, when the spine attachment feature of each hook feature is longitudinally disposed within the spine.

In the example of FIGS. 1 and 2, the first connecting portion 25a of the first hook feature 19a is located adjacent an upper end 27 of the attachment edge 9a and the first spine attachment portion 23a extends parallel to the attachment edge from the first connecting portion toward a lower end 29 of the attachment edge. Conversely, the second connecting portion 25b of the second hook feature 19b is located adjacent the lower end 29 of the attachment edge 9a and the second spine attachment portion 23b extends parallel to the attachment edge from the second connecting portion toward the upper end 27 of the attachment edge.

According to one exemplary implementation, the first and second spine attachment portions 23a and 23b each have a length greater than or equal to approximately 1.30 cm (0.51 in). The first and second spine attachment portions 23a and 23b may each have a width greater than or equal to approximately 0.50 cm (0.20 in) or 0.60 cm (0.24 in). The first and second connecting portions 25a and 25b may each have a width less than or equal to approximately 1.00 cm (0.39 in) or 0.70 cm (0.28 in). According to one implementation, the first and spine attachment portions 23a and 23b have a length of 1.50 cm (0.59 in), a width of 0.65 cm (0.26 in), and a thickness of 0.80 mm (0.03 in), and the first and second connecting portions 25a and 25b have a width of 0.57 cm (0.22 in) and a thickness of 0.80 mm (0.03 in), or approximations thereof, though such dimensions are merely exemplary and any suitable dimensions may be used.

While FIGS. 1 and 2 show one embodiment of a divider that may be coupled to, removed from and easily repositioned within a notebook, many variations are possible. For example, while the first and second hook features 19a and 19b are respectively located adjacent the upper end 27 and lower end 29 of the attachment edge 9a of the panel 3 in the example of FIGS. 1 and 2, one or both of the hook features may alternatively be located at an intermediary position adjacent the attachment edge. Further, while the first and second spine attachment portions 23a and 23b of the first and second hook features 19a and 19b respectively extend toward the lower end 29 and the upper end 27 of the attachment edge 9a, either or both of the first and second spine attachment portions 23a and 23b may alternatively extend in an opposite direction and the location of the associated connecting portion or portions may be correspondingly changed. For example, the following configurations are possible: (1) both of the first and second hook features 19a and 19b may have the orientation of the first hook feature shown in FIGS. 1 and 2, (2) both the first and second hook features 19a and 19b may have the orientation of the second hook feature shown in FIGS. 1 and 2, (3) the orientations of the first and second hook features 19a and 19b shown in FIGS. 1 and 2 may be reversed, or (4) the first and second hook features 19a and 19b may have the orientations shown in FIGS. 1 and 2. Further, it should be appreciated that the repositionable notebook attachment feature 5 need not include two hook features. For example, the repositionable notebook attachment feature 5 may alternatively comprise one hook feature, such as one of first and second hook features 19a and 19b, or more than two hook features.

Other shapes for the first and second hook features 19a and 19b are also possible. For example, the first and second spine attachment portions 23a and 23b may be, at least in part, non-parallel to the attachment edge 9a. According to one exemplary implementation, the first and/or second spine attachment portion may comprise a portion extending parallel to the top and bottom edges 9c and 9d, in a direction away from the panel 3, such that the first and/or second spine attachment portion exits the spine of a notebook to which the divider 1 is coupled in a direction perpendicular to the longitudinal length of the spine. As another example, the first and second spine attachment portions 23a and 23b may be curved and at least substantially non-parallel to the attachment edge 9a. As yet another example, the first and second hook features 19a and 19b may be non-planar and/or may engage with individual coils of a spine.

Similar to the panel 3, the first and second hook features 19a and 19b and/or the reinforcement portion 17 of the repositionable notebook attachment feature 5 may have a sheet-like configuration. For example, the first and second hook features 19a and 19b and/or the reinforcement portion 17 may be planar or substantially planar and have a width no greater than 1.00 mm (0.04 in), though other dimensions and configurations are possible. According to one exemplary implementation, the first and second hook features 19a and 19b and/or the reinforcement portion 17 are configured to be resiliently flexible. For example, the first and second hook features 19a and 19b and/or the reinforcement portion 17 may be composed of a thermoplastic polymer, such as polypropylene. The repositionable notebook attachment feature 5 may be formed by extruding the desired panel shape from a larger sheet of material, such as polypropylene. Of course, the first and second hook features 19a and 19b and the reinforcement portion 17 are not limited to any particular material, and other materials, such as paper, may alternatively be used.

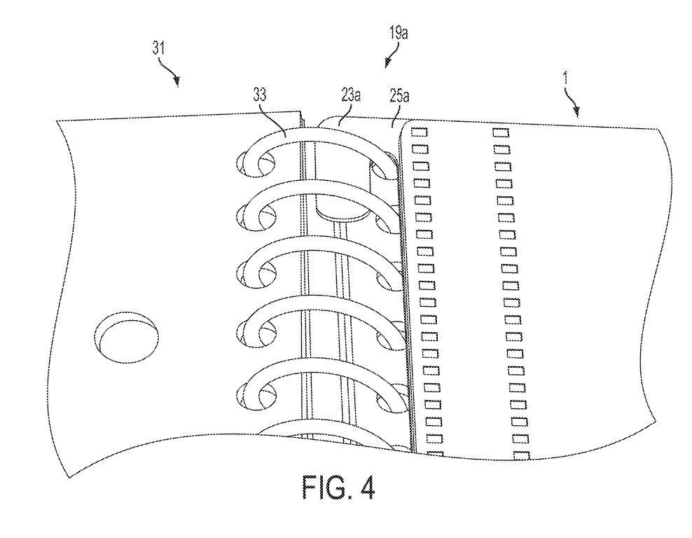

Having described an exemplary embodiment of a repositionable divider 1 that may be used in connection with a notebook, an exemplary use of such a divider will now be described. FIG. 3 shows the divider 1 of FIGS. 1 and 2 coupled to a notebook 31. In particular, the first and second spine attachment features 23a and 23b of the divider 1 are shown longitudinally disposed within the spine 33 of the notebook. An enlarged view of the first spine attachment feature 23a longitudinally disposed within the spine 33 in shown in FIG. 4.

In FIGS. 3 and 4, the first and second hook features 19a and 19b are positioned such that the first and second connecting portions 25a and 25b are disposed outside the spine. Alternatively, however, the divider and/or notebook could be configured or positioned such that one or more of the connecting portions are disposed between spirals of the spine 33. Further, in the example of FIGS. 1-5, the notebook 31 is a spiral bound notebook, with the spine 33 comprising a coil. The coil may be formed of metal or plastic, for example. However, it should be appreciated that the divider 1 may be coupled to other types of notebooks, such as comb-bound notebooks in which the spine comprises a comb binding, in a corresponding manner.

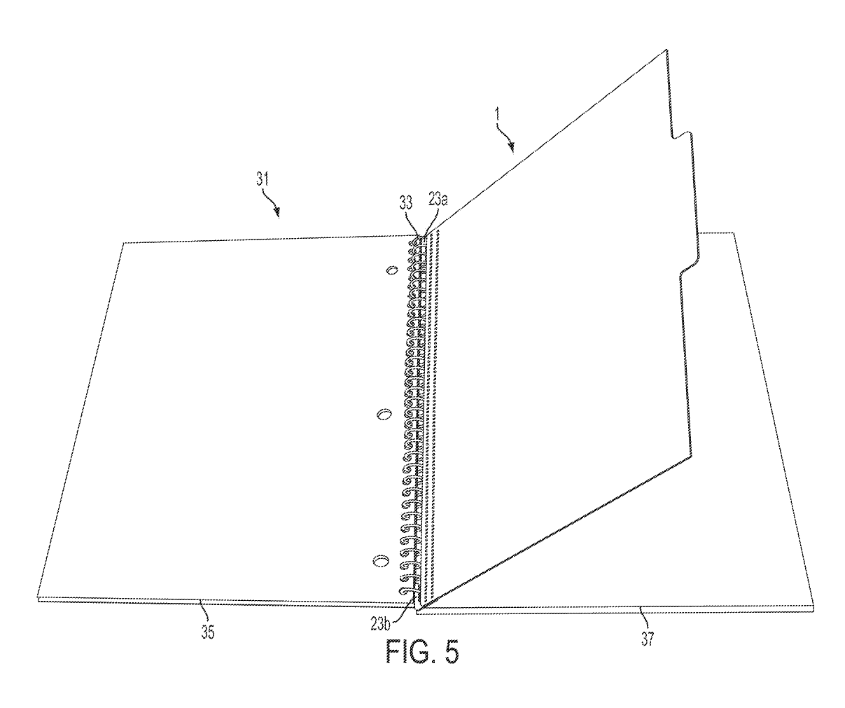

The divider 1 may be rotatable with respect to the spine 33, as illustrated in FIG. 5, enabling the divider 1 to be turned in the same manner as the sheets of paper in the notebook 31. In FIG. 5, the divider 1 is rotatably coupled to the spine at a location within the notebook 31 selected so as to separate a first section 35 of pages from a second section 37 of pages. To insert or remove one or more of the first and second spine attachment features 23a and 23b from the spine 33, for example to reposition the divider 1 at a different location within the notebook 31, each spine attachment feature may be slid longitudinally with respect to the spine. To facilitate such removal or insertion, the corresponding hook feature may be flexed or otherwise manipulated. The sheet-like configuration and/or resiliently flexible nature of the hook feature may facilitate manipulating the hook feature in this manner, although the hook feature need not include these aspects.

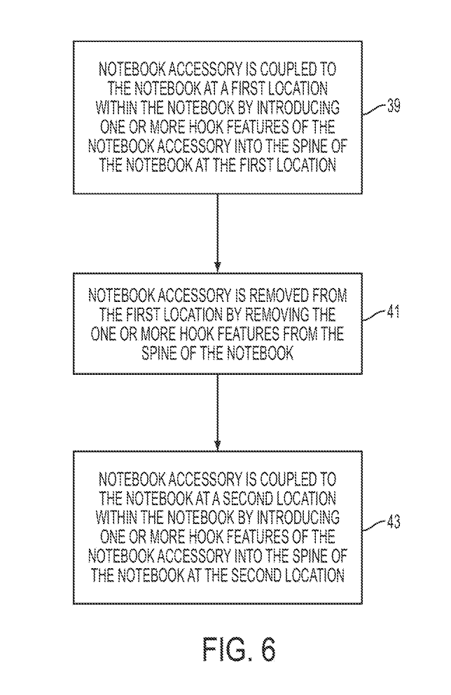

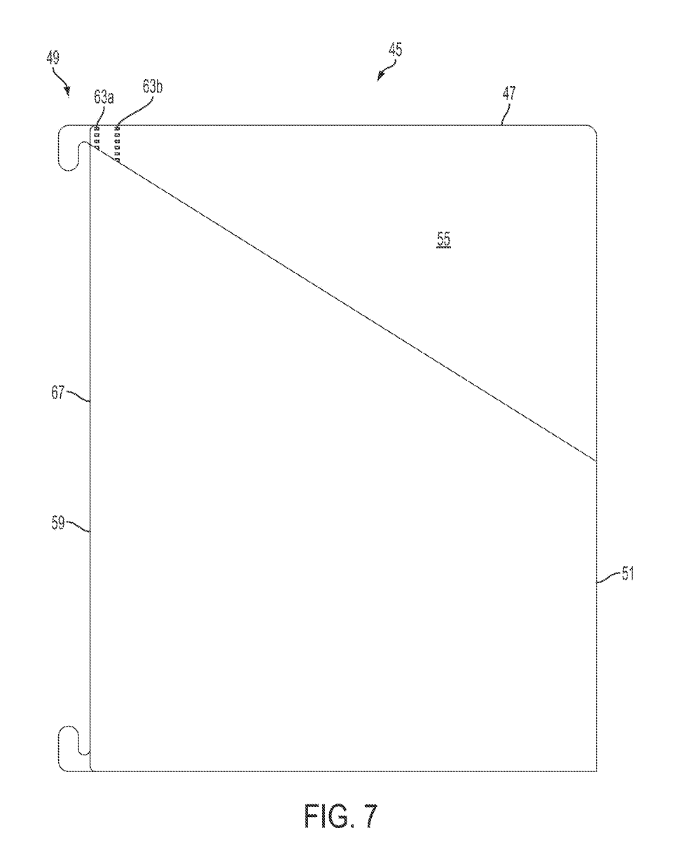

FIG. 6 shows a flowchart illustrating an exemplary method for repositioning a notebook accessory, such as the divider 1 described in connection with FIGS. 1-5, within a notebook. At step 39, the notebook accessory is coupled to the notebook at a first location within the notebook. This may be accomplished by introducing at least a portion of one or more hook features of the notebook accessory into the spine of the notebook, as described herein, at the first location. The first location may be between selected pages of the notebook or some other location, such as in front of the front cover or behind the rear cover of the notebook. At step 41, the notebook accessory is decoupled from the notebook, for example by removing the one or more hook features from the spine of the notebook. At step 43, the notebook accessory is coupled to the notebook at a second location within the notebook, different from the first location. Similar to step 39, this may be accomplished by introducing at least a portion of one or more hook features of the notebook accessory into the spine of the notebook at the second location. The second location may be between different selected pages of the notebook or some other different location. The method described above may also be used in connection with an adhesive flag holder or folder notebook accessory. Such accessories will be described in connection with FIGS. 7-12.

### Repositionable Folder

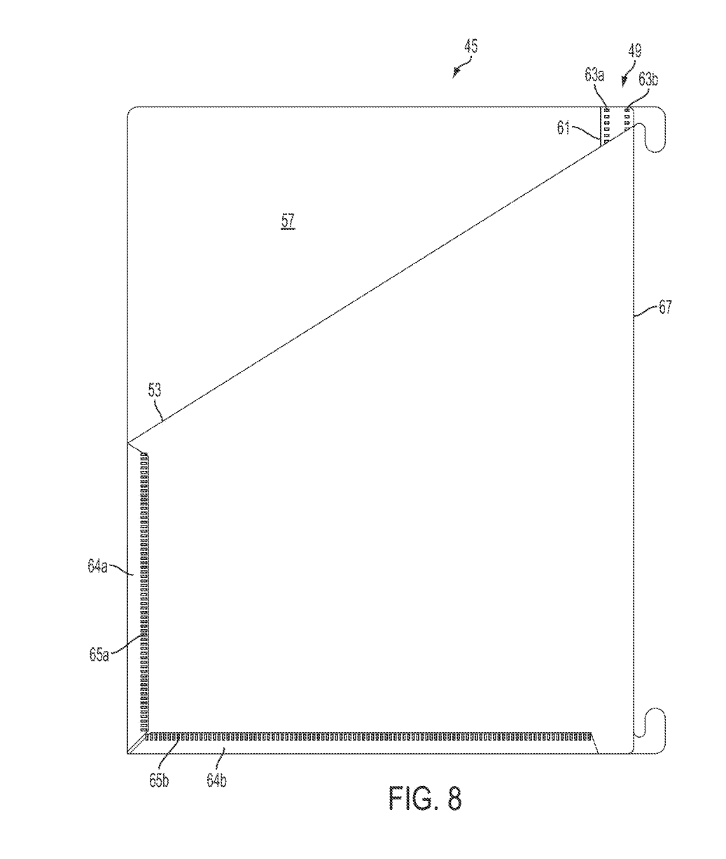

FIGS. 7 and 8 illustrate one embodiment of a repositionable folder 45 that may be used in connection with a notebook. FIG. 7 shows a front view of the folder 45, while FIG. 8 shows a rear view. The folder 45 may be used to store papers or other items and/or to divide sections of paper in the notebook, such as sections pertaining to a particular subject or topic. As used herein, the term “folder” refers to an item having at least one storage pocket or the like, and not necessarily to a folded item. As shown, the folder 45 includes a first panel 47 and a repositionable notebook attachment feature 49 coupled thereto. The first panel 47 and repositionable notebook attachment feature 49 may be the same as the panel 3 and repositionable notebook attachment feature 5 shown and described in connection with FIGS. 1-5 and may have any of the properties discussed in connection with those figures. Accordingly, these aspects of the folder 45 will not be described anew. The folder 45 additionally includes a second panel 51 (FIG. 7) and a third panel 53 (FIG. 8) coupled to the first panel 47. The second panel 51 forms a pocket between the front surface 55 of the first panel 47 and the second panel, while the third panel 53 forms a pocket between the rear surface 57 of the first panel 47 and the third panel.

The second panel 51 may be coupled to the first panel 47 by a weld or other attachment mechanism or may be unitarily formed with the first panel. As discussed herein, the term “coupled to” and variations thereof is intended to encompass not only scenarios in which an attachment mechanism such as a weld, adhesive or fastener is used, but also scenarios in which coupled features are portions of a unitary article. In the example of FIGS. 7 and 8, the second panel 51 and first panel 47 are unitarily formed and are separated by a fold 59. Similarly, the third panel 53 may be coupled to the first panel 47 by a weld or other attachment mechanism or may be unitarily formed with the first panel. The third panel 53 may be coupled to the first panel 47 by a flap (not shown) overlaying the reinforcement portion and welded to the reinforcement portion 61 via welds 63a and 63b. As with any of the other welds discussed herein, the welds 63a and 63b may be formed by sonic welding or some other welding technique.

The second panel 51 is coupled to the third panel 53 by flaps 64a and 64b, which are welded to the third panel via welds 65a and 65b, respectively. In the example of FIGS. 7 and 8, the second panel 51 and third panel 53 are only coupled to the first panel 47 along attachment edge 67. However, the second panel 51 and third panel 53 may alternatively be coupled to the first panel 47 along two or three edges. For example, in cases where the folder 45 includes only two panels and a single pocket therebetween, it may be necessary or desirable to couple the panels along two or three edges in order to form a pocket.

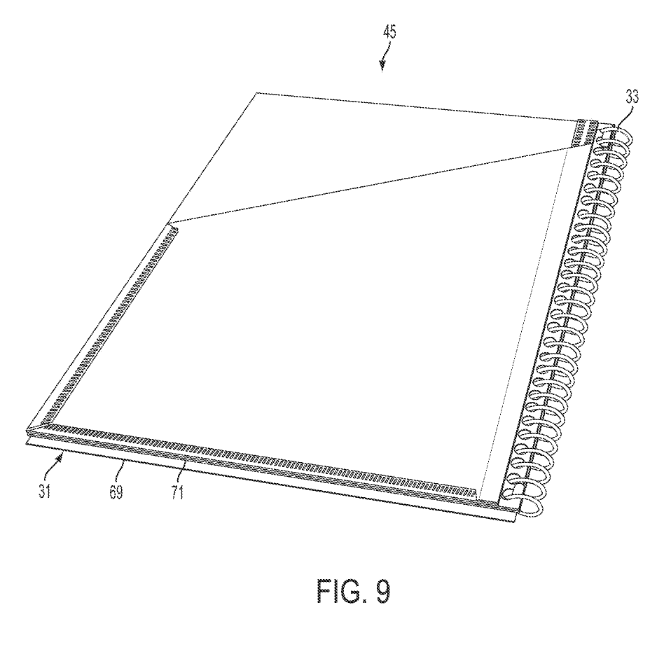

The folder 45 may be coupled to and decoupled from a notebook in the same manner as the divider 1 discussed herein, enabling the folder 45 to be positioned at various locations with respect to the notebook. For example, the folder 45 may be positioned between pages of a notebook, in front of the front cover of a notebook, or behind the back cover of a notebook. Illustratively, FIG. 9 shows the folder 45 positioned behind the back cover 71 of the notebook 31. In this location, the folder 45 may be flipped so as to be in front of the front cover 69 of the notebook 31 without decoupling the folder from the notebook.

### Repositionable Adhesive Flag Holder

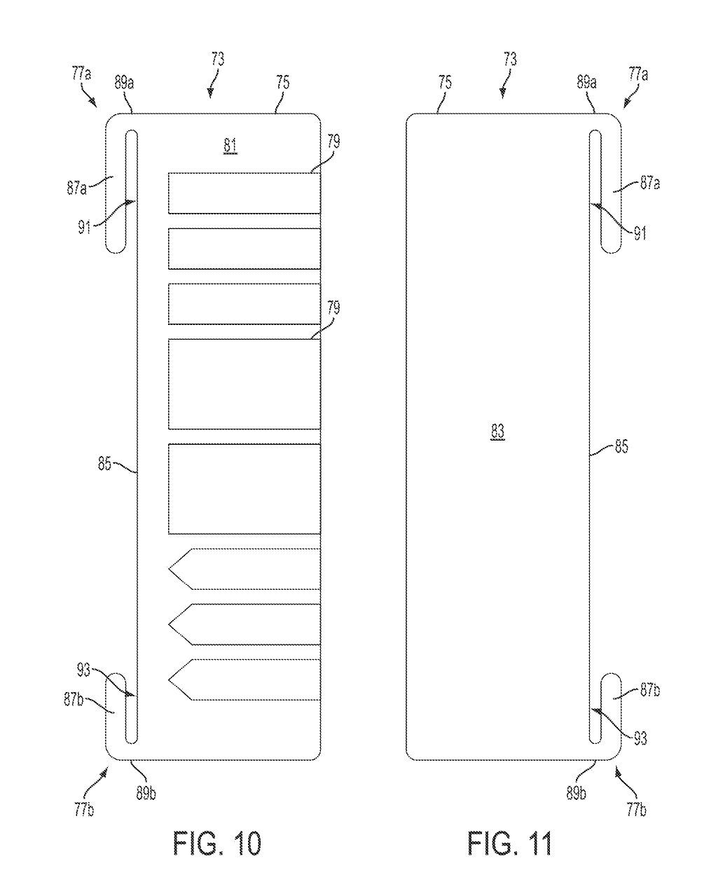

FIGS. 10 and 11 illustrate one embodiment of an adhesive flag holder 73 that may be used in connection with a notebook. FIG. 10 shows a front view of the adhesive flag holder 73, while FIG. 11 shows a rear view. The adhesive flag holder 73 comprises a panel 75, first and second hook features 77a and 77b, and adhesive flags 79 coupled to a front surface 81 of the panel 75. The adhesive flag holder 73 may be coupled to a notebook so that the adhesive flags 79 are readily accessible during use of the notebook.

Similar to the other panels discussed herein, the panel 75 may have a sheet-like configuration, with a small distance separating its front surface 81 and rear surface 83. For example, the panel 75 may be planar or substantially planar and have a width no greater than 1.00 mm (0.04 in), though other dimensions and configurations are possible. According to one implementation, the panel 75 has a length of 19.05 cm (7.50 in), a width of 5.08 cm (2.00 in), and a thickness of 0.80 mm (0.03 in), though such dimensions are merely exemplary and any suitable dimensions may be used.

The first and second hook features 77a and 77b are coupled to an attachment edge 85 of the panel 75. Similar to the other hook features described herein, the first and second hook features 77a and 77b respectively comprise first and second spine attachment portions 87a and 87b and first and second connecting portions 89a and 89b that couple the spine attachment portions to the attachment edge 85. The hook features 77a and 77b are configured and arranged to couple the panel 75 to a spine of a notebook, such as the notebooks described herein, when the spine attachment feature of each hook feature is longitudinally disposed within the spine.

In the example of FIGS. 10 and 11, the first connecting portion 89a of the first hook feature 77a is located adjacent an upper end 91 of the attachment edge 85 and the first spine attachment portion 87a extends parallel to the attachment edge from the first connecting portion toward a lower end 93 of the attachment edge. Conversely, the second connecting portion 89b of the second hook feature 77b is located adjacent the lower end 93 of the attachment edge 85 and the second spine attachment portion 87b extends parallel to the attachment edge from the second connecting portion toward the upper end 91 of the attachment edge. Alternatively, however, the hook features 77a and 77b can have any of the other hook feature configurations discussed herein, for example in connection with the divider of FIGS. 1-5.

According to one exemplary implementation, the first and second spine attachment portions 87a and 87b each have a length greater than or equal to approximately 1.30 cm (0.51 in). The first and second spine attachment portions 87a and 87b may each have a width greater than or equal to approximately 0.50 cm (0.20 in) or 0.60 cm (0.24 in). The first and second connecting portions 89a and 89b may each have a width less than or equal to approximately 1.00 cm (0.39 in) or 0.70 cm (0.28 in). According to one implementation, the first spine attachment portion 87a has a length of 4.50 cm (1.77 in), a width of 0.65 cm (0.26 in), and a thickness of 0.80 mm (0.03 in), the second spine attachment portion 87b has a length of 2.70 cm (1.06 in), a width of 0.65 cm (0.26 in), and a thickness of 0.80 mm (0.03 in), and the first and second connecting portions 89a and 89b have a width of approximately 0.70 cm (0.28 in) and a thickness of 0.80 mm (0.03 in), or approximations thereof, though such dimensions are merely exemplary and any suitable dimensions may be used.

According to one exemplary implementation, the panel 75 and/or the first and second hook features 77a and 77b are configured to be resiliently flexible. For example, the panel 75 and/or the first and second hook features 77a and 77b may be composed of a thermoplastic polymer, such as polypropylene. Other materials, such as paper, are also possible. The panel 75 and first and second hook features 77a and 77b may be unitarily formed by extruding the desired shape of the panel and hook features from a larger sheet of material, such as polypropylene. Alternatively, the first and second hook features 77a and 77b may coupled to the panel using an attachment mechanism.

The adhesive flags 79 are arranged in stacks that are coupled to the front surface 81 of the panel 75. The adhesive flags 79 may be adhered to pages of a notebook to identify locations of interest, provide notations or for other purposes. According to one exemplary implementation, the flags are constructed of oriented polypropylene (OPP) film, although other materials, such as paper, may alternatively be used. According to one implementation, the flags have a writable surface, for example a surface that can be written on using conventional pen ink. A re-adherable adhesive, such as an acid free adhesive acrylic, may be disposed on the back of each flag so that the flags may be adhered to and repositioned on surfaces of a notebook. The flags may have any suitable shape, such as an arrow or rectangle. It should be appreciated that the flags need not serve an identifying function, such as by flagging a particular location, and may simply serve as notepaper.

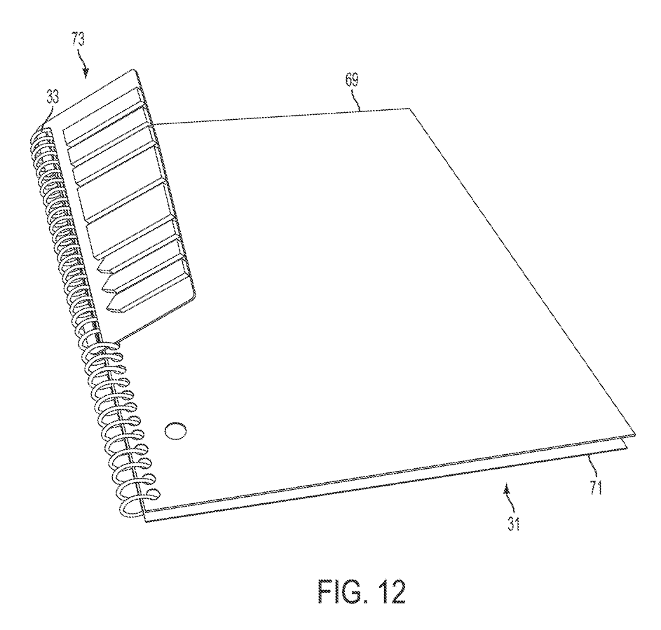

The adhesive flag holder 73 may be coupled to and decoupled from a notebook in the same manner as the divider and folder discussed herein, and enabling the adhesive flag holder to be positioned at various locations with respect to a notebook. For example, the adhesive flag holder 73 may be positioned between pages of a notebook, in front of a front cover of the notebook, or behind a back cover of the notebook. Illustratively, FIG. 12 shows the adhesive flag holder 73 positioned in front of the front cover 69 of the notebook 31. In this location, the adhesive flag holder 73 may be flipped so as to be in back of the back cover 71 of the notebook 31 without decoupling the adhesive flag holder from the notebook.

### CONCLUSION

Aspects of the divider, folder, and adhesive flag holder described in embodiments herein may be combined is various ways to obtain a repositionable notebook accessory having a plurality of functions. For example, such an accessory may include both a tab and at least one pocket, so as to perform both a dividing function and a storage function. Similarly, a divider or folder accessory may include adhesive flags stacked thereon. Various modifications to the repositionable notebook accessories described herein are also possible. For example, such accessories may be printed with useful information (e.g., equations, conversion tables and/or a ruler), such that the information may be made available at various useful locations in or on a notebook.

While various inventive embodiments have been described and illustrated herein, those of ordinary skill in the art will readily envision a variety of variations and/or modifications that performing the function and/or obtain one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A repositionable notebook accessory comprising:
a panel comprising a plurality of edges, the plurality of edges including an attachment edge; and
at least one hook feature, each hook feature comprising a spine attachment portion and a connecting portion that couples the spine attachment portion to the attachment edge of the panel, wherein the at least one hook feature is configured and arranged to couple the panel to a spine of a notebook when the spine attachment feature of each hook feature is longitudinally disposed within the spine.

2. The repositionable notebook accessory of claim 1, wherein the at least one hook feature comprises first and second hook features.

3. The repositionable notebook accessory of claim 2, wherein the first hook feature comprises a first connecting portion located adjacent an upper end of the attachment edge and a first spine attachment portion extending parallel to the attachment edge from the first connecting portion toward a lower end of the attachment edge.

4. The repositionable notebook accessory of claim 3, wherein the second hook feature comprises a second connecting portion located adjacent an upper end of the attachment edge and a second spine attachment portion extending parallel to the attachment edge from the second connecting portion toward the upper end of the attachment edge.

5. The repositionable notebook accessory of claim 1, wherein:
the at least one hook feature comprises a first hook feature comprising a first spine attachment portion extending parallel to the attachment edge and a first connecting portion between the first spine attachment portion and the panel; and
the first spine attachment portion has a length greater than or equal to approximately 1.3 cm.

6. The repositionable notebook accessory of claim 5, wherein the first spine attachment portion has a width greater than or equal to approximately 0.5 cm.

7. The repositionable notebook accessory of claim 6, wherein the first spine attachment portion has a width greater than or equal to approximately 0.6 cm.

8. The repositionable notebook accessory of claim 5, wherein the first connecting portion has a width less than or equal to approximately 1 cm.

9. The repositionable notebook accessory of claim 8, wherein the first connecting portion has a width less than or equal to approximately 0.7 cm.

10. The repositionable notebook accessory of claim 1, wherein the at least one hook feature has a sheet-like configuration.

11. The repositionable notebook accessory of claim 10, wherein the at least one hook feature is resiliently flexible.

12. The repositionable notebook accessory of claim 10, wherein the at least one hook feature is composed of a thermoplastic polymer.

13. The repositionable notebook accessory of claim 12, wherein the at least one hook feature is composed of polypropylene.

14. The repositionable notebook accessory of claim 1, wherein the repositionable notebook accessory is a repositionable divider, and the divider comprises a tab feature coupled to the panel.

15. The repositionable notebook accessory of claim 14, wherein the tab feature is coupled to an edge of the panel that is opposite the attachment edge.

16. The repositionable notebook accessory of claim 14, wherein the panel and the tab feature are portions of a unitary sheet.

17. The repositionable notebook accessory of claim 1, further comprising a stack of adhesive flags coupled to the panel.

18. The repositionable notebook accessory of claim 1, wherein the repositionable notebook accessory is a repositionable folder and wherein the repositionable folder further comprises:
at least one additional panel coupled to the panel, wherein the at least one additional panel is constructed and arranged to form at least one pocket between the panel and the at least one additional panel.

19. The repositionable notebook accessory of claim 18, wherein the at least one additional panel is coupled to the panel along the attachment edge of the panel.

20. The repositionable notebook accessory of claim 1, wherein the panel has a width that is approximately 8.5 inches and a length that is approximately 11 inches.

21. The repositionable notebook accessory of claim 1, wherein the panel has a thickness that is less than 1 mm.

22. A method of using a repositionable notebook accessory in connection with a notebook comprising a spine, the accessory comprising a panel and at least one hook feature coupled to the panel, the method comprising:
introducing at least a portion of the at least one hook feature into the spine of the notebook at a first location within the notebook so as to couple the accessory to the notebook at the first location.

23. The method of claim 22, wherein each hook feature of the at least one hook feature comprises a spine attachment portion and a connecting portion that couples the spine attachment portion to the attachment edge of the panel, and wherein introducing the at least a portion of the at least one hook feature into the spine of the notebook at the first location within the notebook comprises:
introducing at least a portion of the at least one hook feature into the spine of the notebook such that the spine attachment feature of each hook feature is longitudinally disposed within the spine.

24. The method of claim 22, further comprising:
removing the at least a portion of the at least one hook feature from the spine of the notebook so as to decouple the accessory from the notebook.

25. The method of claim 24, further comprising:
introducing the at least a portion of the at least one hook feature into the spine of the notebook at a second location within the notebook so as to couple the accessory to the notebook at the second location.

26. The method of claim 22, wherein the at least one hook feature comprises first and second hook features, and wherein introducing the at least a portion of the at least one hook feature into the spine of the notebook at the first location within the notebook comprises:
introducing the first and second hook features into the spine of the notebook.

27. The method of claim 22, wherein the at least one hook feature is composed of a resiliently flexible material, and wherein introducing the at least a portion of the at least one hook feature into the spine of the notebook at the first location within the notebook comprises:
flexing the at least one hook feature.

28. The method of claim 22, wherein the spine comprises a spiral or comb binding.

29. The method of claim 22, wherein the repositionable notebook accessory is a repositionable divider, and the divider comprises a tab feature coupled to the panel.

30. The method of claim 22, wherein the repositionable notebook accessory comprises a stack of adhesive flags coupled to the panel.

31. The method of claim 22, wherein the repositionable notebook accessory is a repositionable folder and wherein the repositionable folder further comprises at least one additional panel coupled to the panel, wherein the at least one additional panel is constructed and arranged to form at least one pocket between the panel and the at least one additional panel.

32. A repositionable notebook accessory comprising:
a panel; and
at least one hook feature configured and arranged to couple the panel to a spine of a notebook when the at least one hook feature is at least partially disposed within the spine;
wherein the repositionable notebook accessory is selected from the group consisting of (1) a divider comprising a tab feature coupled to the panel, (2) an adhesive flag holder comprising a stack of adhesive flags coupled to the panel, and (3) a folder comprising at least one additional panel coupled to the panel, wherein the at least one additional panel is constructed and arranged to form at least one pocket between the panel and the at least one additional panel.

33. The repositionable notebook accessory of claim 32, wherein the repositionable notebook accessory is the divider.

34. The repositionable notebook accessory of claim 32, wherein the repositionable notebook accessory is the adhesive flag holder.

35. The repositionable notebook accessory of claim 32, wherein the repositionable notebook accessory is the folder.

36. The repositionable notebook accessory of claim 32, wherein each hook feature of the at least one hook feature comprises a spine attachment portion and a connecting portion that couples the spine attachment portion to an edge of the panel, and wherein the at least one hook feature is configured and arranged to couple the panel to a spine of a notebook when the spine attachment feature of each hook feature is disposed within the spine.

37. The repositionable notebook accessory of claim 32, wherein the at least one hook feature comprises first and second hook features.
